(19) United States
(12) Patent Application Publication
(10) Pub. No.: US 2007/0299211 A1
(43) Pub. Date: Dec. 27, 2007

(54) Ambient temperature rapid self-polymerization compositions of high cross-linked or linear type beta-amino-ester alternative co-polymers and their applications

(75) Inventors: Po-Cheng Chen, Hsin-Chu City (TW); Shih-Chieh Wang, Taipei Hsien (TW); Chia-Yu Huang, Taichung City (TW); Kan-Nan Chen, Taipei City (TW)

Correspondence Address: BACON & THOMAS, PLLC, 625 SLATERS LANE, FOURTH FLOOR, ALEXANDRIA, VA, 22314, US

(73) Assignee: Tamkang University, Taipei Hsien (TW)

(21) Appl. No.: 11/478,676

(22) Filed: Jul. 3, 2006

(30) Foreign Application Priority Data
Jun. 21, 2006 (TW) 095122223

(51) Int. Cl. C08F 120/02

(52) U.S. Cl. 525/329.7; 525/475

(57) ABSTRACT

Self-polymerization of mono-aziridine (or azetidine) and multi-aziridine (or azetidine) containing compounds with vinyl group containing organic acid, such as acrylic acid (AA), 2-methylenesuccinic acid, 2,3-dimethylenesuccinic acid and etc, at ambient temperature results in the new type of cross-linked and linear type copolymers, respectively.

The polymerization of multi-functional aziridine (or azetidine) containing compounds with vinyl group containing organic acid results in the formation of high cross-linked polymers. The self-polymerization takes place at ambient temperature and the resultants, cross-linked polymeric networked materials, are solvent insoluble and potential for adhesive, composite matrix and other applications. These insoluble materials are hydrolyzed in an acidic or basic condition to form the water soluble β-amino acids.

A linear poly(β-aminoester) is obtained from the self-polymerization of vinyl group containing organic acid with mono-aziridine (or azetidine) containing compound at ambient temperature. poly(β-aminoester) is applicable for gene transfer, controlled drug release and other applications. This self-polymerization process offers a convenient route for preparing poly(β-aminoesters).

### FIELD OF THE INVENTION

This invention relates to an ambient temperature self-polymerization compositions of high cross-linked or linear type β-amino-ester alternative co-polymers and their applications, especially for a new high cross-linked or linear type poly(β-amino-esters) copolymers obtained by a rapid self-polymerization of an α,β-unsaturated organic acid (e.g. acrylic acid) and a multi-aziridine (or azetidine) or mono-aziridine (or azetidine) containing compound at ambient temperature.

The rapid self-polymerization combines three different reactions in a sequential process. These three different reactions consist of an exothermic acid-base neutralization reaction, the heat accelerates a ring-opening reaction for an amino ester bond formation; and its amino group precedes the inter- and intra-molecular Michael addition reaction with α,β-unsaturated double bonds of the acrylates. Finally it results a high cross-linked or linear type poly(β-amino-esters) copolymers with large amounts of β-amino-ester linkages that totally depends on the number of aziridine (or azetidine) functionality of monomers. The obtained high cross-linked poly(β-amino-esters) co-polymers are water-insoluble and organic solvent resistant materials. However, these co-polymers can be hydrolyzed to water soluble poly(β-amino acids) in a diluted aqueous acidic or basic solution.

These self-polymerization compositions and the resulting cross-linked poly(β-amino-esters) co-polymers are suitable for industrial applications, such as adhesive, composite matrix materials, and etc.

### DESCRIPTION OF THE PRIOR ART

Most conventional liquid type polymer for broadening final application, a cross-linker is needed to enhance the molecular weight and polymer network formations of final polymers. Normally a cross-linker or an additional energy is required such as heat, ultra-violet, electron-beam or even a catalyst etc.

A multi-aziridine containing compound serves as a latent cross-linking agent for a curable system of self-emulsified aqueous epoxy resin and its polymeric hybrids (U.S. Pat. No. 6,291,554). This cross-linking reaction takes place between aziridine of the latent curing agent and carboxylic acid of the self-emulsified epoxy oligomer at ambient temperature without extra energy input or catalyst. It results in an amino ester bond formation among polymers at the first stage and furthermore, its amino group reacts further with epoxy end groups of the oligomer. This aziridine containing compound serves only as a cross-linking agent for waterborne polymers.

At present, there are limited examples of self-polymerized materials, which are water-insoluble and organic solvent resistant high cross-linked co-polymers. These cross-linked co-polymers are obtained from a mixture of liquid monomers without extra energy or catalyst. So far there is not any of this water-insoluble high cross-linked polymer can be hydrolyzed into a water soluble polymer in an aqueous acidic or basic solution.

### SUMMARY OF THE INVENTION

The rapid self-polymerization of multi-aziridine (or azetidine) and mono-aziridine (or azetidine) containing compounds with α,β-unsaturated organic acid, such as acrylic acid (AA), at ambient temperature results in the novel type of cross-linked or linear type co-polymers, respectively. The self-polymerization process is controlled by its monomers composition, pH value and polymerization medium. This novel self-polymerization process involves three reactions in a sequential stage, stage I: acid-base neutralization reaction, stage II: ring-opening reaction and stage III: an inter- and intra-molecular Michael addition reaction and results in cross-linked or linear type of polymeric materials formation. This self-polymerization process involves three exothermic reactions in sequential, therefore, the self-polymerization can be very rapid. Its self-polymerization rate can be controlled either by adjusting its pH value of monomers or using an organic solvent, or water as self-polymerization medium.

This self-polymerization process takes place at ambient temperature and forming cross-linked polymeric networked materials. These cross-linked polymers are water insoluble and organic solvent resistant. However, these insoluble polymers are easily hydrolyzed in an aqueous acidic or basic solution and forming water soluble poly(β-amino acids).

A linear poly(β-amino-ester) co-polymer is obtained from the self-polymerization compositions of mono-aziridine (or azetidine) containing compound and AA at ambient temperature. This linear poly(β-amino-ester) co-polymer is non-toxic, which is applicable for gene transfer, controlled drug release and other applications.

This self-polymerization process offers a convenient route for preparing poly(β-amino-esters) and poly(β-amino acids).

### DETAILED DESCRIPTION OF THE INVENTION

A model reaction has been designed to demonstrate the reaction mechanism of self-polymerization of aziridine (or azetidine) containing compound with acrylic acid. A mono-aziridine (or azetidine) containing compound is prepared. This aziridine (or azetidine) moiety plays as a nucleophile to attack methyl acrylate via a Michael addition reaction and forms methyl 3-(aziridin-1-yl) propanoate (MAP) or MAzeP (azetidine is used to replace aziridine). The preparation processes of MAP and MAzeP are illustrated as Schemes I and II.

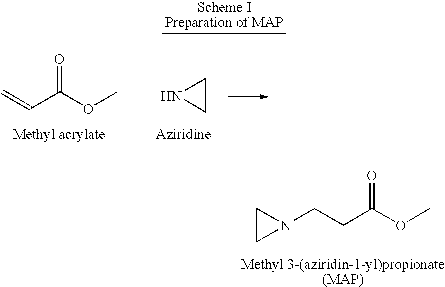

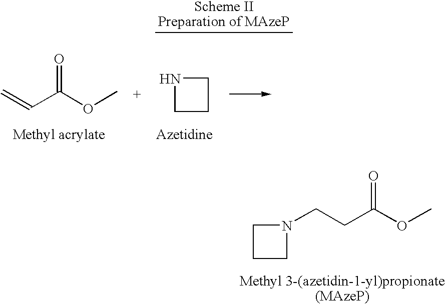

A model reaction of stages I and II is carried out by using a trimethylacetic acid (TMAA) and mixing with MAP. The intermediates of acid-base neutralization reaction (stage I) and ring-opening reaction (stage II) are characterized respectively. An amino ester compound, 2-(3-methoxy-3-oxopropyl amino)propyl pivalate (TMAA-MAP), of the ring-opening product is obtained by reacting with an α,β-unsaturated carbonyl compound, e.g. ethyl acrylate (EA), undergoing an inter-molecular Michael addition reaction (stage III) and forming 3-((3-ethoxy-3-oxopropyl)(3-methoxy-3-oxopropyl)amino)propyl pivalate (MAP-TMAA-EA) (Scheme III), which can be isolated and identified.

If MAzeP is used in a model reaction and a product, 2-((3-ethoxy-3-oxopropyl)(3-methoxy-3-oxopropyl)amino)ethyl pivalate (MAzeP-TMAA-EA) is obtained (Scheme IV).

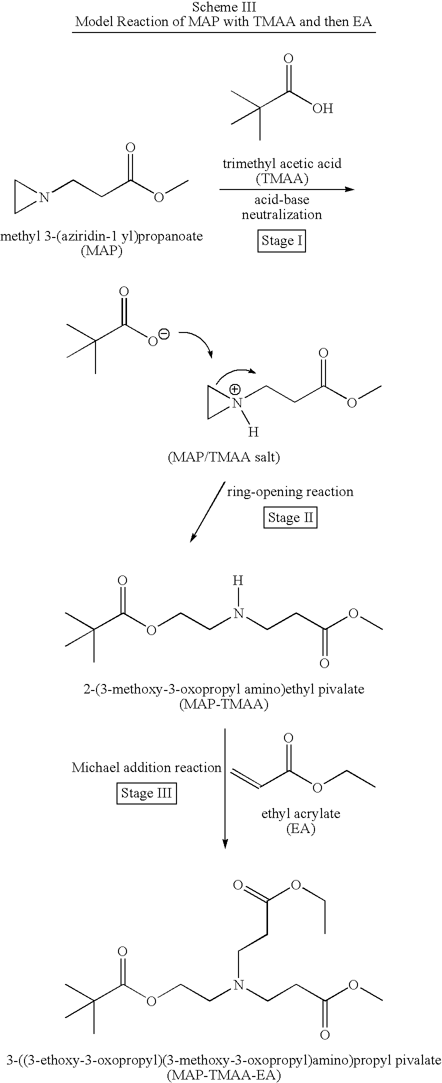

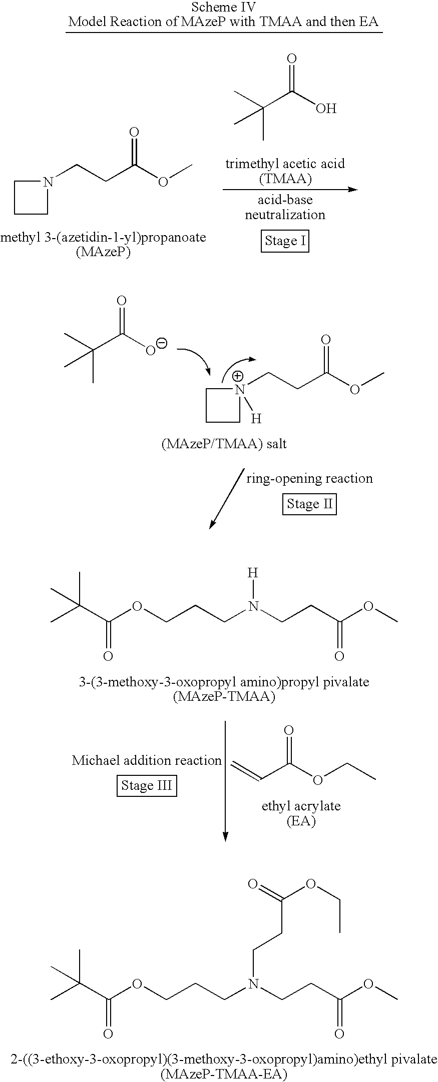

The reaction products of mono-aziridine (or azetidine) containing compound reacting with trimethyl acetic acid (TMMA) and ethyl acrylate (EA) are isolated and characterized, which can demonstrate the reaction mechanism. A polymerization of mono-aziridine containing compound, methyl 3-(aziridin-1-yl)-propanoate (MAP) with an α,β-unsaturated organic acid, e.g. acrylic acid (AA) can be resulted in a linear poly(β-amino-ester) formation at ambient temperature. And the reaction mechanism is similar to the modeling reaction of MAP with trimethylacetic acid (TMAA) and ethyl acrylate (EA), which starts from an exothermic acid-base neutralization of carboxylic acid (of AA) with AZ (of MAP) and results in a quaternary aziridinium salt adduct. A ring-opening reaction is triggered by that neutralization heat and forming an amino-ester bond. And that amino group reacts further with α,β-unsaturated C═C double bond of acrylate (of AA) via a Michael addition reaction for a second β-amino-ester bond formation and results in a linear poly(β-amino-esters) (Scheme VI). For the case of a mono-azetidine compound (MAzeP) is replacing mono-aziridine containing compound, methyl 3-(aziridin-1-yl) propanoate (MAP) and a similar linear poly(β-amino-esters) are obtained (Scheme VII).

A multi-aziridine containing compound, e.g. trimethylolpropane tris(1-aziridinyl)propionate (TMPTA-AZ) is selected and synthesized for replacing a mono-aziridine containing compound, MAP. A rapid polymerization takes place immediately on mixing of AA with TMPTA-AZ and it results in a novel high cross-linked polymeric network formation at ambient temperature (Scheme VIII). The rapid polymerization process of these two monomers AA and TMPTA-AZ is similar to that of the linear poly(β-amino-esters) formation (Scheme VI). This bulk polymerization process takes place between these two monomers at ambient temperature.

This process is an exothermic reaction that can be easily controlled by using organic solvent or water as a polymerization media and the high cross-linked co-polymers, poly(β-amino-esters) are obtained after solvent or water is removed. These poly(β-amino-esters) are insoluble in water or any organic solvents.

There is an alternative method for controlling the self-polymerization rate by adjusting pH value of α,β-unsaturated organic acid, (e.g. acrylic acid) to about 8.0 with tri-ethyl amine (TEA). A homogeneous mixture of acrylic acid amine salt and TMPTA-AZ remains stable at ambient temperature, and then the polymerization takes place slowly when the amine is removed gradually. This polymerization process is controlled by pH value that is very convenient for various applications.

This rapid self-polymerization of AA and TMPTA-AZ takes place and results in high cross-linked polymers, poly(β-amino-esters) formation at ambient temperature without external heating or catalyst. Furthermore, these poly(β-amino-esters) can be hydrolyzed into water-soluble β-amino acids.

This rapid self-polymerization provides a convenient process for making water and organic solvent resistant polymers, which has the potential for instant adhesive, sealant, composite material or other applications.

### DESCRIPTION OF THE PREFERRED EMBODIMENTS

The following examples serve to illustrate the preferred embodiment of the present invention but the present invention is not introduced to be limited to the details thereof.

### Preparation of Methyl 3-(aziridin-1-yl)propanoate (MAP)

Methyl acrylate (MA) is treated with an excess amount of aziridine (AZ) dichloromethane solution in an ice bath (molar ratio of MA/AZ=1.0/1.1). After the addition of AZ, the reaction temperature is kept at room temperature for 3 hours until an absorption peak at 1635 cm⁻¹ of acrylic double bond disappears on IR spectrum. At last, the excess of aziridine and solvent are removed by reduced pressure distillation. The product, a mono-aziridine containing compound, MAP is isolated in 96% yield and that is characterized by ¹H-NMR, ¹³C-NMR (FIGS. 1 and 2) and FT-IR (FIG. 3).

### Preparation of Methyl 3-(azetidin-1-yl) propanoate (MAzeP)

Azetidine (Aze) is substituted for AZ and the rest of reaction procedures are similar to synthesis of MAP to obtain MAzeP, which can be characterized by ¹H-NMR, ¹³C-NMR (FIGS. 4 and 5) and FT-IR (FIG. 6).

### Preparation of α,β-Unsaturated Organophosphonic Acid (HEMA-POH)

The reactants used are 2-hydroxyethyl methacrylate (2-HEMA) and P₂O₅, and the solvent can be toluene, Dichloromethane (DCM) or tetrahydro furan (THF) (Scheme V). The reaction was under the ice-bath condition and the 2-HEMA was added dropwisely into P₂O₅. The excess P₂O₅ was removed by using filtration when the solution changed to slightly yellowish color but clearness. Then a suitable amount of mixture of acetone and deionized water was added. After complete mixing, the solvent including acetone and deionized water were removed by using the thin film distillation. The product was confirmed by the FT-NMR (FIG. 7, 8) and FTIR (FIG. 9).

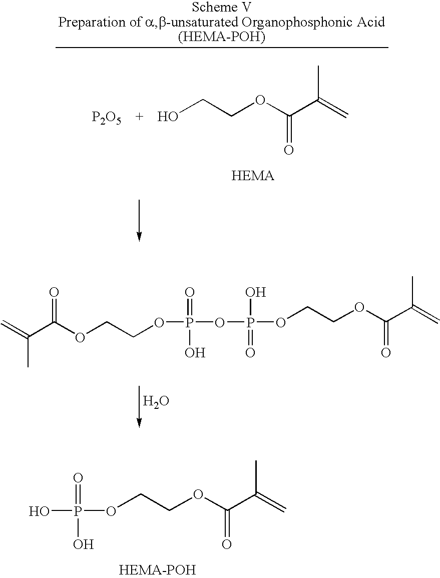

### Model Reaction of MAP with TMAA and then with EA (Scheme III)

### Stage I: Neutralization of MAP with TMAA (MAP/TMAA Salt)

A CDCl₃ solution of MAP (0.01 mole) added dropwisely into a CDCl₃ solution of trimethyl acetic acid (TMAA, 0.01 mole) for neutralization in an ice bath. The MAP/TMAA salt is identified by the FT-NMR (FIG. 10b)

### Stage II: Ring-Opening Adduct of MAP/TMAA Salt

MAP/TMAA salt is heated further to produce a ring-opening reaction and form an amino ester bond of 2-(3-methoxy-3-oxopropyl amino)ethyl pivalate (MAP-TMAA) that is characterized by FT-NMR (FIG. 10c).

### Stage III: Michael Addition of Ring Opening Adduct to Ethyl Acrylate

Ring opening adduct of MAP/TMAA is mixed with an excess amount of ethyl acrylate (EA), a Michael addition reaction takes place between the EA and an amino group of ring opening adduct. The final product, MAP-TMAA-EA, is identified by the FT-NMR (FIG. 10d).

### Model Reaction of MAzeP and TMAA and then with EA (Scheme V)

MAzeP is substituted for MAP and the rest of reaction procedures are similar to Scheme III.

### EXAMPLE 1

### Linear Polymer from MAP with Acrylic Acid (Scheme VI)

MAP, a mono-aziridine containing compound is prepared previously, which is mixed with acrylic acid (AA) (MAP/AA=1.0/1.0) in aqueous solution at room temperature. It results in self-polymerization and forms a water-soluble linear copolymer of poly(β-amino-esters) with a weight average molecular weight (Mw) of 11,300. When dimethyl formamide (DMF) is selected as a solvent, its Mw of self-polymerization product is 25,800. Mw of all resulting polymers is measured by an aqueous GPC (gel permeation chromatography) and polyethylene glycols are served as the standard.

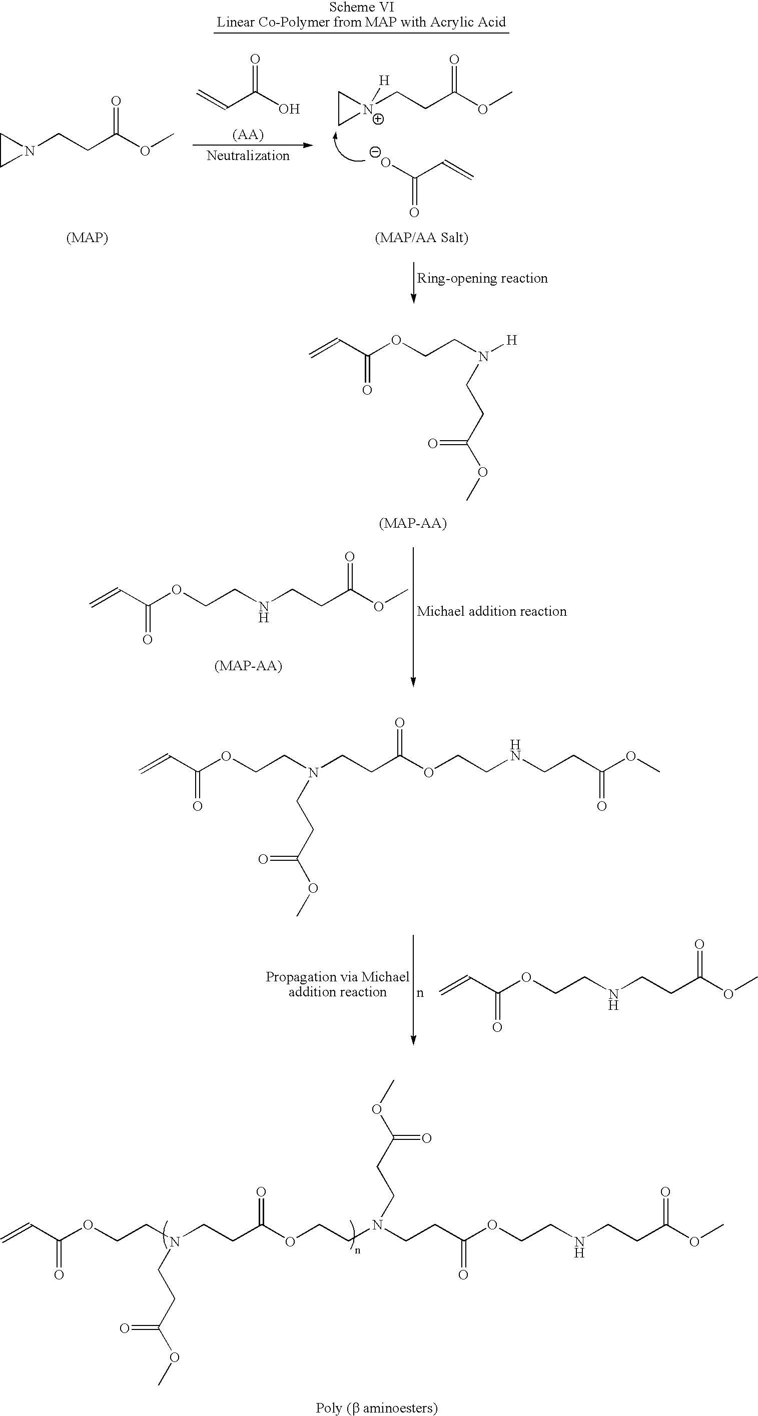

### EXAMPLE 2

### Linear Polymer from MAzeP with Acrylic Acid (Scheme VII)

MAzeP is substituted for MAP and the rest of reaction procedures are similar to Example 1. Its Mw of final linear alternative copolymer is 11,000 and 24,000, which are prepared in aqueous and DMF solution, respectively.

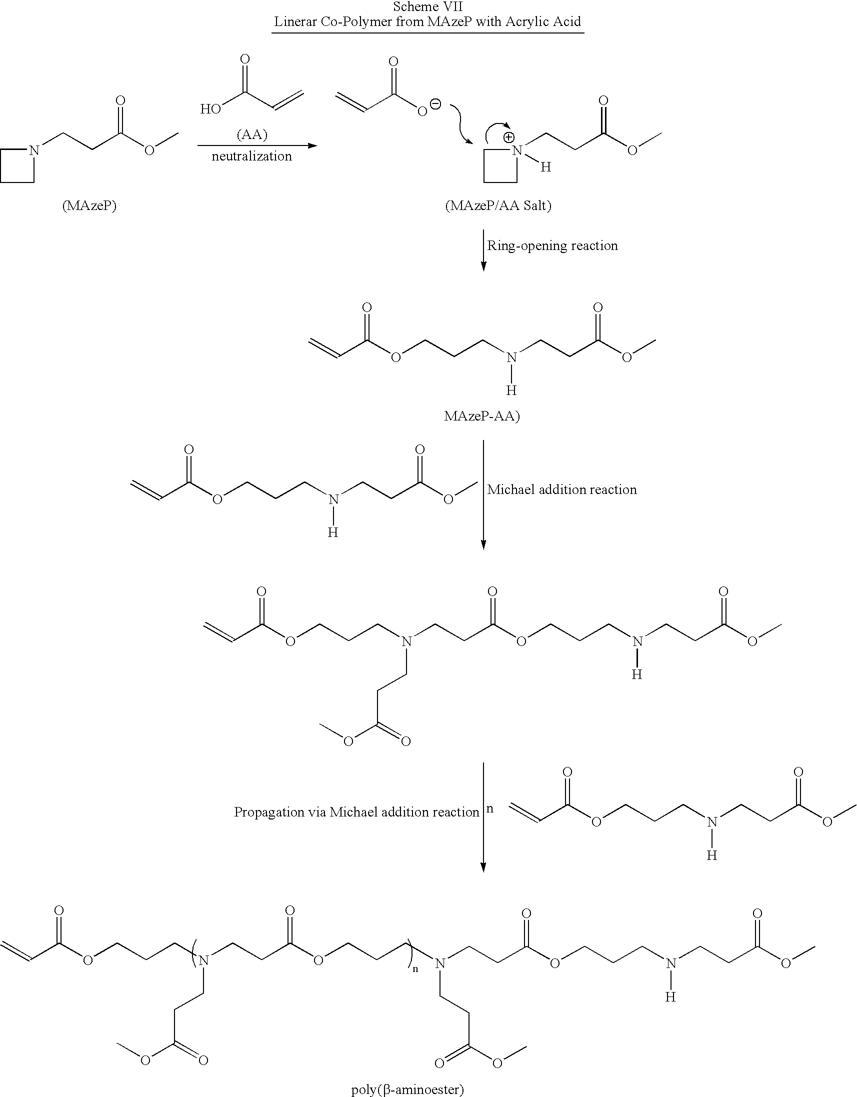

### EXAMPLE 3

### High Cross-Linked Polymers from a Rapid Self-Polymerization of a Multi-Aziridine Containing Compound and Acrylic Acid (Scheme VIII)

A rapid self-polymerization occurs on the mixture of a multi-aziridine containing compound, such as trimethylolpropane tris(1-aziridinyl) propionate (TMPTA-AZ) with acrylic acid in various equivalent ratio of COOH/aziridine. A suitable ratio of acrylic acid is added into TMPTA-AZ slowly with a high speed agitation in an ice bath. The reaction mixture is cast on the glass plate and allows warming up to ambient temperature. It results in a formation of organic solvents and water insoluble high cross-linked polymers.

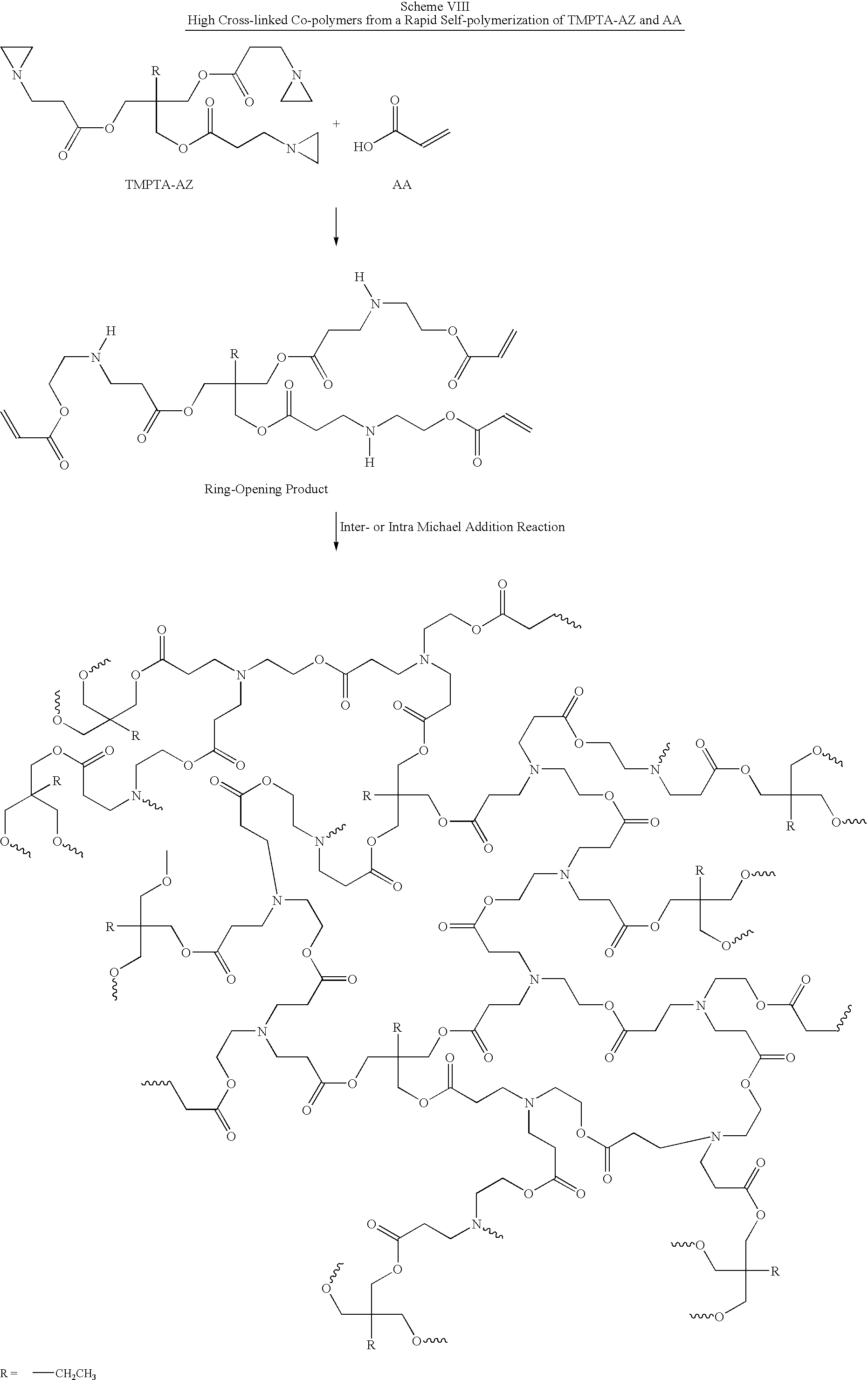

### EXAMPLE 4

### High Cross-Linked Polymers from a Rapid Self-Polymerization of a Multi-Azetidine Containing Compound and Acrylic Acid

A multi-azetidine containing compound, e.g. trimethylolpropane tris(1-azetidenyl)propionate (TMPTA-Aze) is substituted for TMPTA-AZ in the self-polymerization process. It results in a formation of high cross-linked with organic solvents and water insoluble polymers (Scheme IX).

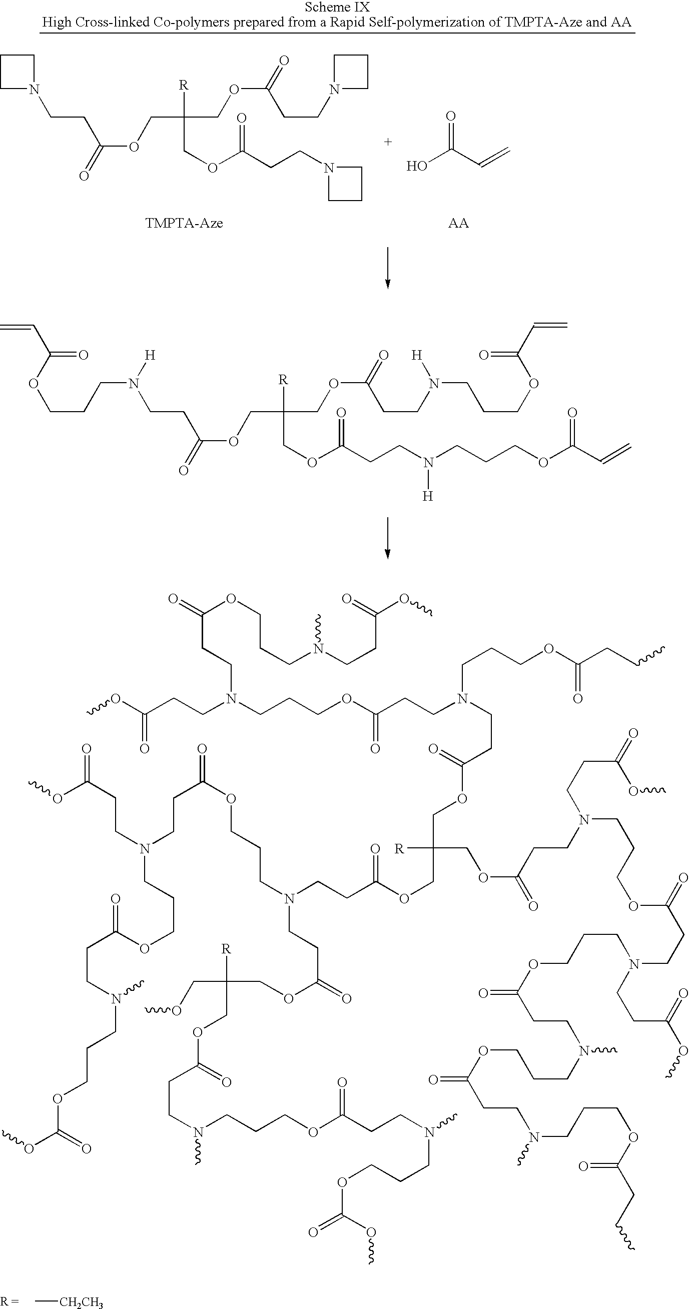

### EXAMPLE 5

### High Cross-Linked Polymers Prepared from a Rapid Self-Polymerization of a Multi-Aziridine (or Azetidine) Containing Compound and an α,β-Unsaturated Organophosphonic Acid

A rapid self-polymerization occurs on the mixture of a multi-aziridine containing compound, such as trimethylolpropane tris(1-aziridinyl) propionate (TMPTA-AZ) with an α,β-unsaturated phosphonic acid in various equivalent ratio of phosphonic acid/aziridine. A suitable ratio of phosphonic acid is added into TMPTA-AZ slowly with a high speed agitation in an ice bath. The reaction mixture is cast on the glass plate and allows warming up to ambient temperature. It results in a formation of organic solvents and water insoluble high cross-linked polymers containing both phosphorus and nitrogen. This self-polymerized material has a synergetic flame retardation effect. Its limiting oxygen index (LOI) is 30-32.

### BRIEF DESCRIPTION OF DRAWING

FIG. 1 is a ¹H-NMR spectrum of Methyl 3-(aziridin-1-yl)propanoate (MAP) used in preparation of linear type β-amino-ester alternative co-polymers of this invention.

FIG. 2 is a ¹³C-NMR spectrum of Methyl 3-(aziridin-1-yl)propanoate (MAP) used in preparation of linear type β-amino-ester alternative co-polymers of this invention.

FIG. 3 is a FT-IR spectrum of Methyl 3-(aziridin-1-yl)propanoate (MAP) used in preparation of linear type β-amino-ester alternative co-polymers of this invention.

FIG. 4 is a ¹H-NMR spectrum of Methyl 3-(azetidin-1-yl) propanoate (MAzeP) used in preparation of linear type β-amino-ester alternative co-polymers of this invention.

FIG. 5 is a ¹³C-NMR spectrum of Methyl 3-(azetidin-1-yl) propanoate (MAzeP) used in preparation of linear type β-amino-ester alternative co-polymers of this invention.

FIG. 6 is a FT-IR spectrum of Methyl 3-(azetidin-1-yl) propanoate (MAzeP) used in preparation of linear type β-amino-ester alternative co-polymers of this invention.

FIG. 7 is a ¹H-NMR spectrum of α,β-unsaturated Organophosphonic Acid (HEMA-POH) used in preparation of high cross-linked type β-amino-ester alternative co-polymers of this invention.

FIG. 8 is a ¹³C-NMR spectrum of α,β-unsaturated Organophosphonic Acid (HEMA-POH) used in preparation of high cross-linked type β-amino-ester alternative co-polymers of this invention.

FIG. 9 is a FT-IR spectrum of α,β-unsaturated Organophosphonic Acid (HEMA-POH) used in preparation of high cross-linked type β-amino-ester alternative co-polymers of this invention.

FIG. 10 is ¹H-NMR spectra of product from each stage model reaction in preparation of β-amino-ester alternative co-polymers of this invention.

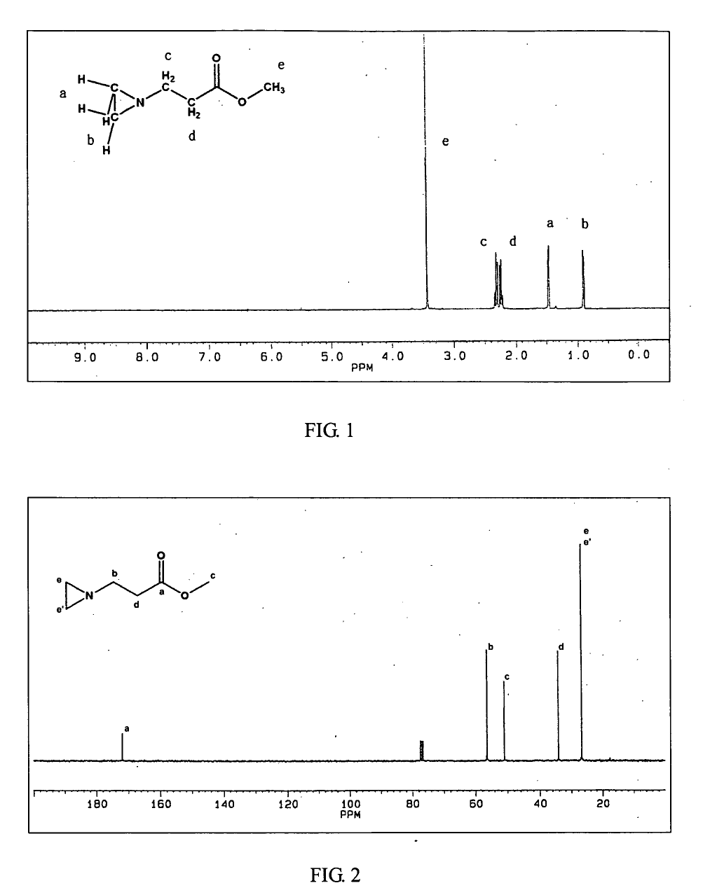

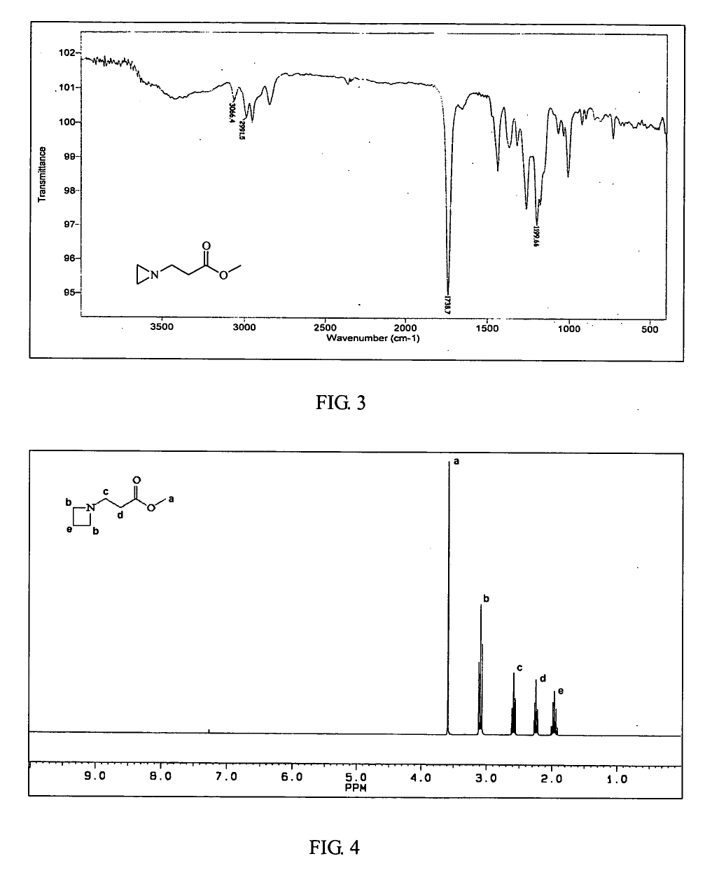

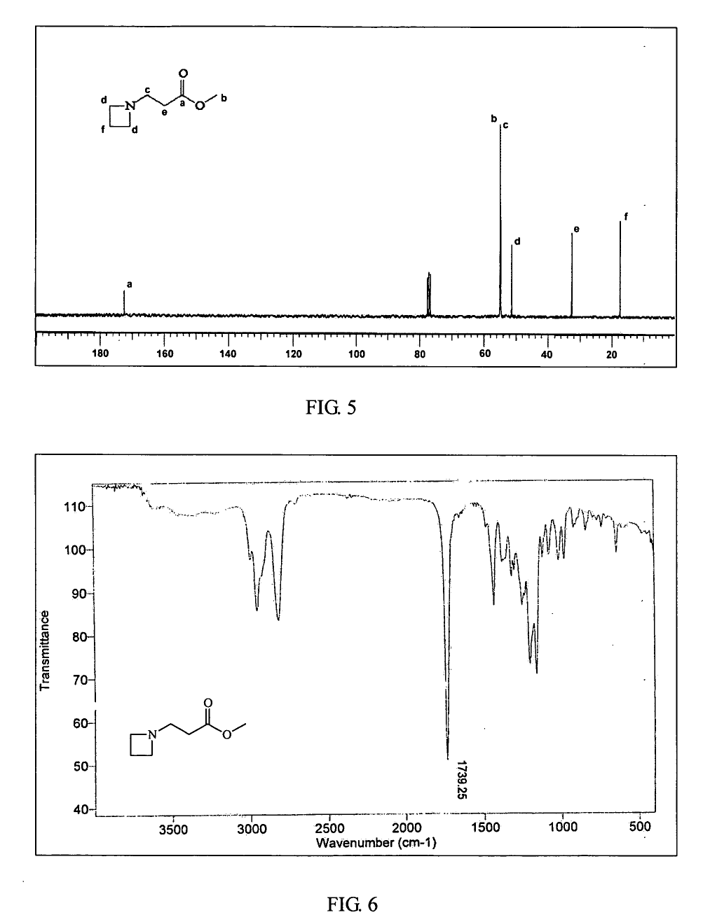

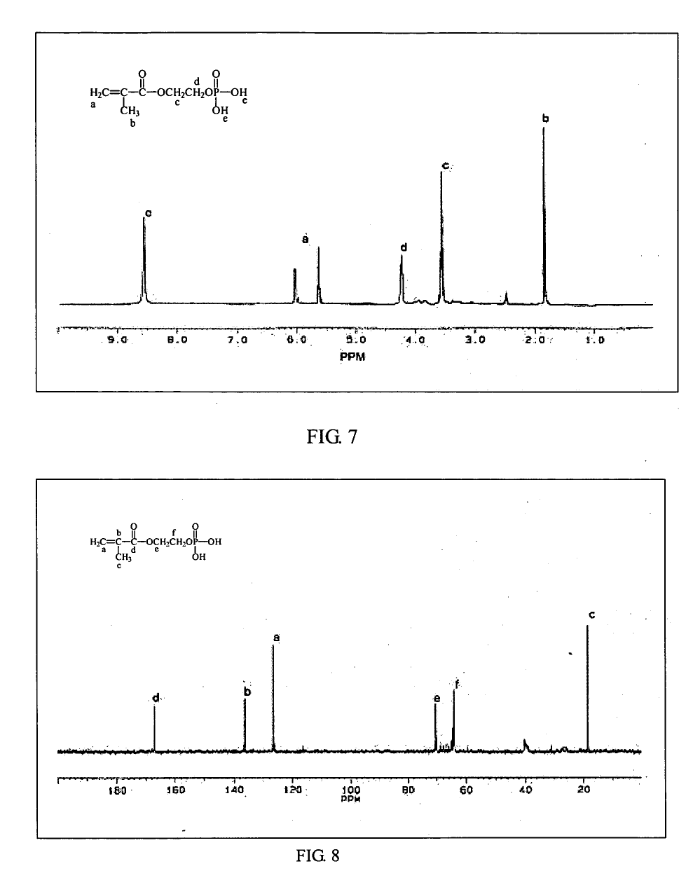

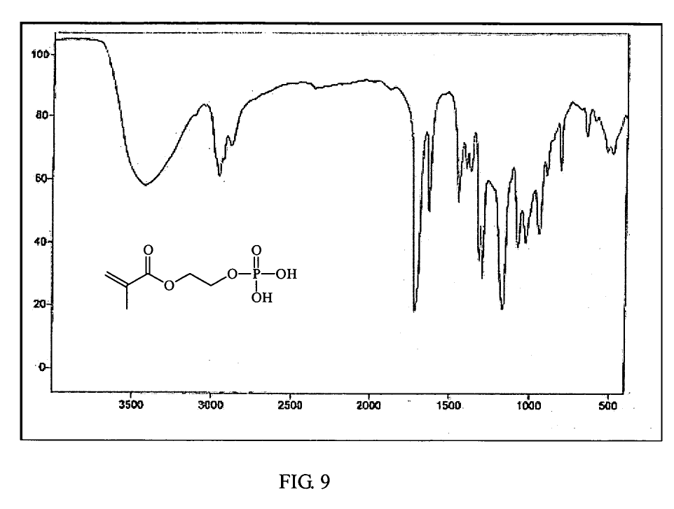

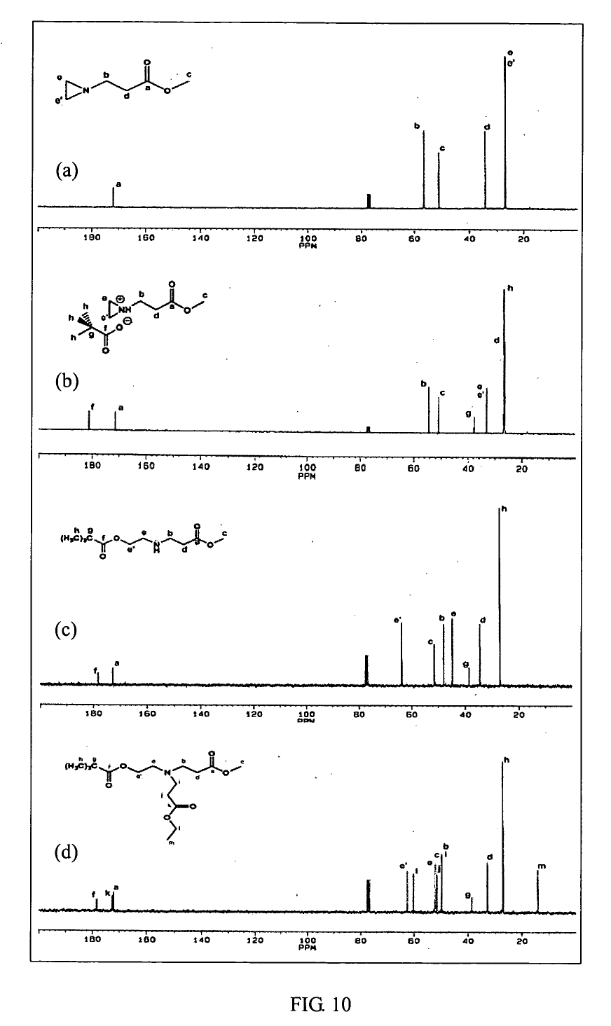

What is claimed is:

1. A rapid self-polymerization composition of high cross-linked co-polymer of poly(β-amino-esters), which is characterized in by reacting multi-aziridine (or azetidine) containing compound with an α,β-unsaturated acid without any catalyst or extra cross-linker to obtain a rapid self-polymerization composition of high cross-linked co-polymer of poly(β-amino-esters).

2. The rapid self-polymerization composition according to claim 1, wherein said α,β-unsaturated organic acid is one selected from the group of acrylic acid, methacrylic acid, itaconic acid and α,β-unsaturated phosphonic acid.

3. The rapid self-polymerization system according to claim 1, wherein said self-polymerization can take place in bulk, aqueous phase or organic solvent system.

4. The rapid self-polymerization system according to claim 1, wherein said self-polymerization rate can be controlled by its pH value below 7.0, preferred at 6.0.

5. A rapid self-polymerization composition of linear co-polymer of poly (β-amino-esters), which is characterized in by reacting mono-aziridine (or azetidine) containing compound with an α,β-unsaturated organic acid without any catalyst or energy to obtain a rapid self-polymerization composition of linear type co-polymer of poly (β-amino-esters).

6. The rapid self-polymerization composition according to claim 1, which is suitable in application for adhesives, composites materials, and etc.

7. The rapid self-polymerization composition according to claim 1, wherein said α,β-unsaturated organic acid is α,β-unsaturated phosphonic acid able to provide phosphorus content of cross-linked polymer for P/N synergetic flame retardant polymer materials.

8. The rapid self-polymerization composition according to claim 1, wherein the obtained water or solvent resistant poly(β-amino-esters) can be hydrolyzed to form a water soluble poly(β-amino acids) in the acidic or basic conditions.

9. The rapid self-polymerization composition according to claim 1, wherein said α,β-unsaturated organic acid is replaced by α,β-unsaturated phosphonic acid to get flame retarded high cross-linked co-polymer having LOI over 30.
